(19) United States
(12) Patent Application Publication
(10) Pub. No.: US 2026/0245789 A1
(43) Pub. Date: Aug. 20, 2026

(54) INDUCTOR COMPONENT

(71) Applicant: Murata Manufacturing Co., Ltd., Kyoto-fu (JP)

(72) Inventor: Keisuke KUNIMORI, Nagaokakyo-shi (JP)

(73) Assignee: Murata Manufacturing Co., Ltd., Kyoto-fu (JP)

(21) Appl. No.: 19/641,050

(22) Filed: Apr. 7, 2026

Related U.S. Application Data
(63) Continuation of application No. PCT/JP2024/023190, filed on Jun. 26, 2024.

(30) Foreign Application Priority Data
Oct. 11, 2023 (JP) 2023-176002

(51) Int. Cl. H01F 27/32; H01F 27/28

(52) U.S. Cl. CPC H01F 27/323; H01F 27/2804; H01F 27/2871; H01F 27/327

(57) ABSTRACT

An inductor component includes an element body, a first interlayer insulation layer, an inter-conductor insulation layer, and an inductor conductor. The element body has a first main surface. The first interlayer insulation layer extends parallel to the first main surface in the element body. The first interlayer insulation layer has a flat-plate-like shape. The inter-conductor insulation layer extends from the first interlayer insulation layer in a first positive direction perpendicular to the first main surface. The inductor conductor includes a portion adjacent to the inter-conductor insulation layer in a direction parallel to the first main surface, and extends parallel to the first main surface on the first positive direction side of the first interlayer insulation layer. The inductor conductor is in the form of a line. The first interlayer insulation layer includes a synthetic resin having insulating properties and a plurality of fillers dispersed in the synthetic resin.

### CROSS-REFERENCE TO RELATED APPLICATIONS

This application claims benefit of priority to International Patent Application No. PCT/JP2024/023190, filed Jun. 26, 2024, and to Japanese Patent Application No. 2023-176002, filed Oct. 11, 2023, the entire contents of each are incorporated herein by reference.

### BACKGROUND

### Technical Field

The present disclosure relates to an inductor component.

### Background Art

An inductor component described in Japanese U.S. Pat. No. 6,879,355 includes an element body, a substrate, resin walls, and a coil. The element body has a rectangular-parallelepiped shape. The element body contains a magnetic material. The substrate is made of an insulating material. The substrate has a plate-like shape. The substrate is located in the element body. The resin walls are located on a main surface of the substrate. The resin walls extend in a direction normal to the main surface. The coil is located on the main surface of the substrate in a cross-sectional view of the inductor component taken along a line normal to the main surface of the substrate. A space between adjacent resin walls is filled with the coil.

### SUMMARY

When heat is applied to the inductor component described in Japanese U.S. Pat. No. 6,879,355 in a manufacturing process, the inductor component thermally expands and thermally contracts. When the substrate deforms due to heat in this way, the entirety of the inductor component may become curved. On the other hand, if the thickness of the substrate is increased to suppress deformation of the substrate due to heat, it becomes difficult to reduce the size of the inductor component. Therefore, it is desirable to develop a technique for suppressing curving of an inductor component while suppressing an influence on the dimensions of the inductor component.

Therefore, an inductor component according to an aspect of the present disclosure includes an element body having a main surface; an interlayer insulation layer having a flat plate-like shape and extending parallel to the main surface in the element body; an inter-conductor insulation layer extending from the interlayer insulation layer in a first positive direction perpendicular to the main surface; and an inductor conductor that is in a form of a line, that includes a portion adjacent to the inter-conductor insulation layer in a direction parallel to the main surface, and that extends parallel to the main surface on the first positive direction side with respect to the interlayer insulation layer. The interlayer insulation layer includes a synthetic resin having insulating properties and a plurality of fillers dispersed in the synthetic resin.

With the configuration described above, it is possible to suppress an influence on the dimensions of an inductor component while suppressing curving of the inductor component.

### BRIEF DESCRIPTION OF THE DRAWINGS

FIG. 1 is a perspective view of an inductor component;

FIG. 2 is a transparent side view of the inductor component;

FIG. 3 is a transparent top view of the inductor component;

FIG. 4 is a cross-sectional view of the inductor component taken along line 4-4 in FIG. 3;

FIG. 5 is an enlarged schematic view illustrating the vicinity of a surface of a first interlayer insulation layer in a specific cross section;

FIG. 6 is an enlarged view of a part in FIG. 4;

FIG. 7 illustrates a method of manufacturing the inductor component;

FIG. 8 illustrates the method of manufacturing the inductor component;

FIG. 9 illustrates the method of manufacturing the inductor component;

FIG. 10 illustrates the method of manufacturing the inductor component;

FIG. 11 illustrates the method of manufacturing the inductor component;

FIG. 12 illustrates the method of manufacturing the inductor component;

FIG. 13 illustrates the method of manufacturing the inductor component;

FIG. 14 illustrates the method of manufacturing the inductor component;

FIG. 15 illustrates the method of manufacturing the inductor component;

FIG. 16 illustrates the method of manufacturing the inductor component;

FIG. 17 illustrates the method of manufacturing the inductor component;

FIG. 18 illustrates the method of manufacturing the inductor component;

FIG. 19 illustrates the method of manufacturing the inductor component;

FIG. 20 illustrates the method of manufacturing the inductor component;

FIG. 21 illustrates the method of manufacturing the inductor component;

FIG. 22 illustrates the method of manufacturing the inductor component;

FIG. 23 illustrates the method of manufacturing the inductor component; and

FIG. 24 illustrates the method of manufacturing the inductor component.

### DETAILED DESCRIPTION

Hereafter, an embodiment of an inductor component will be described with reference to the drawings. Constituent elements in the drawings may be enlarged for ease of understanding. Dimensional ratios of constituent elements may differ from actual ratios or differ between drawings.

### Overall Structure

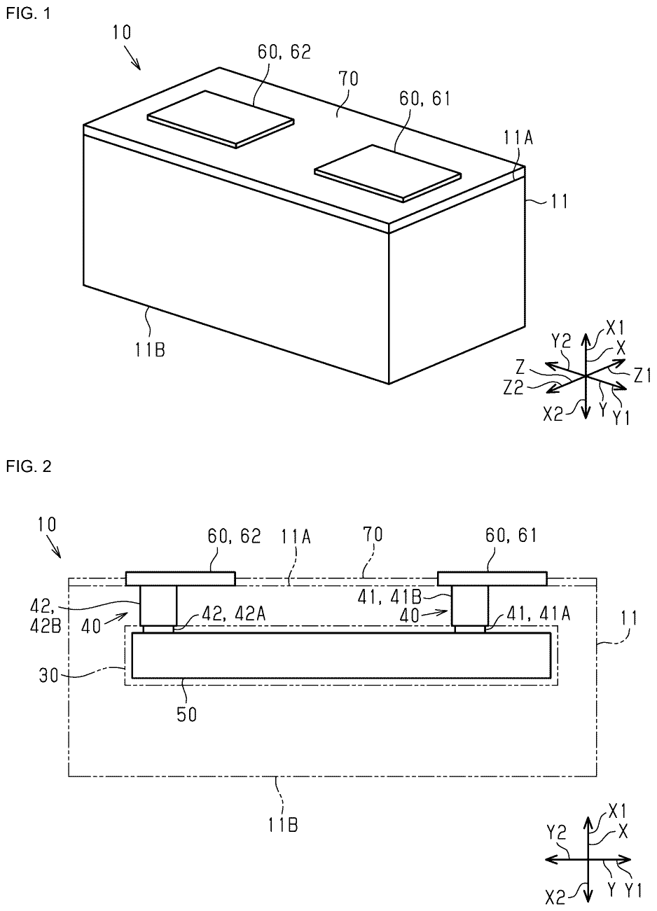

As illustrated in FIG. 1, an inductor component 10 has a substantially rectangular-parallelepiped shape as a whole. As illustrated in FIG. 2, the inductor component 10 includes an element body 11 and an inductor conductor 50.

As illustrated in FIG. 1, the element body 11 has six flat outer surfaces. A first main surface 11A is a specific one of the six outer surfaces. A second main surface 11B is a surface located opposite from the first main surface 11A and parallel to the first main surface 11A. The outer shape of the first main surface 11A and the outer shape of the second main surface 11B are each a rectangular shape. In the present embodiment, the first main surface 11A is a mounting surface that faces a substrate when the inductor component 10 is mounted on the substrate.

Here, a first axis X is an axis perpendicular to the first main surface 11A. A second axis Y is an axis perpendicular to the first axis X and parallel to a specific side of the first main surface 11A, which is a long side of the first main surface 11A in the present embodiment. A third axis Z is an axis perpendicular to the first axis X and the second axis Y. A first positive direction X1 is one of the directions along the first axis X in which the first main surface 11A faces. A first negative direction X2 is a direction opposite to the first positive direction X1. A second positive direction Y1 is a specific one of the directions along the second axis Y. A second negative direction Y2 is a direction opposite to the second positive direction Y1. A third positive direction Z1 is a specific one of the directions along the third axis Z. A third negative direction Z2 is a direction opposite to the third positive direction Z1.

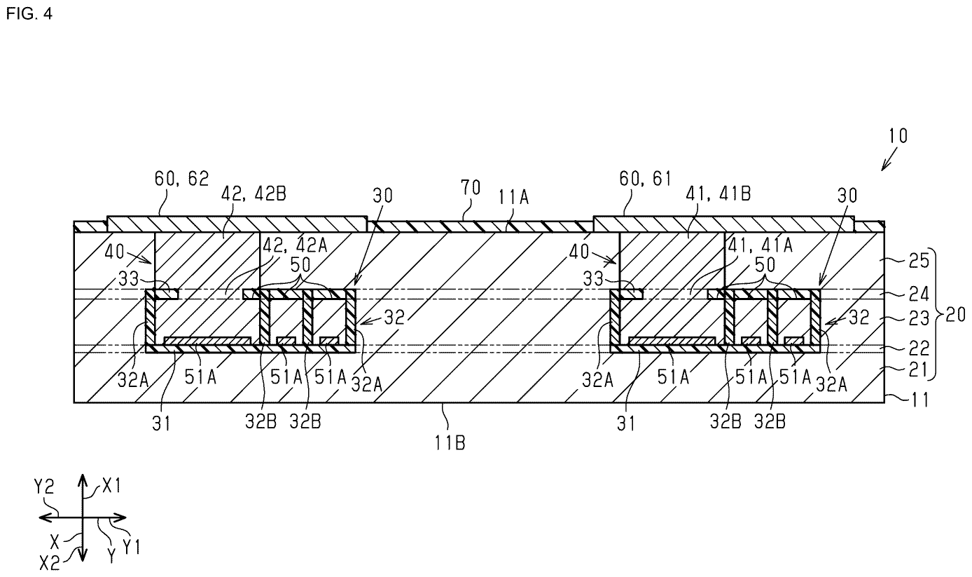

As illustrated in FIG. 4, the element body 11 includes, as magnetic layers 20, a first magnetic layer 21, a first interlayer magnetic layer 22, a second magnetic layer 23, a second interlayer magnetic layer 24, and a third magnetic layer 25, in order from the first negative direction X2 side. Although boundaries between the magnetic layers 20 are shown by two-dot chain lines in FIG. 4, these boundaries between the magnetic layers 20 might not be clearly observable. The material of the magnetic layers 20 is an organic resin containing metal magnetic powder. That is, the element body 11 includes a magnetic material. In the present embodiment, the metal magnetic powder is metal magnetic powder of an Fe-based alloy or an amorphous alloy. To be more specific, the metal magnetic powder is FeSiCr-based metal powder including iron. The metal magnetic powder is not limited to FeSiCr-based magnetic powder, and may be FeCo-based, FeSiAr-based, or iron-oxide-based magnetic powder, or a combination of these. The organic resin may be epoxy-based, imide-base, liquid-crystal-based, acrylic-based, or phenol-based resin, or a combination of these. In the organic resin, inorganic fillers may be mixed with the above material.

As illustrated in FIG. 2, the inductor conductor 50 is located in the element body 11. As illustrated in FIG. 4, the inductor conductor 50 is located at the same position as the second magnetic layer 23 in the first positive direction X1. The material of the inductor conductor 50 is an electroconductive material. In the present embodiment, the composition of the inductor conductor 50 is, for example, a composition such that the proportion of copper is greater than or equal to 99 wt % and the proportion of sulfur is greater than or equal to 0.1 wt % and less than or equal to 1.0 wt % (i.e., from 0.1 wt % to 1.0 wt %). The inductor conductor 50 is not limited to a conductor mainly composed of copper, and may be a conductor mainly composed of Ag, Al, or Au.

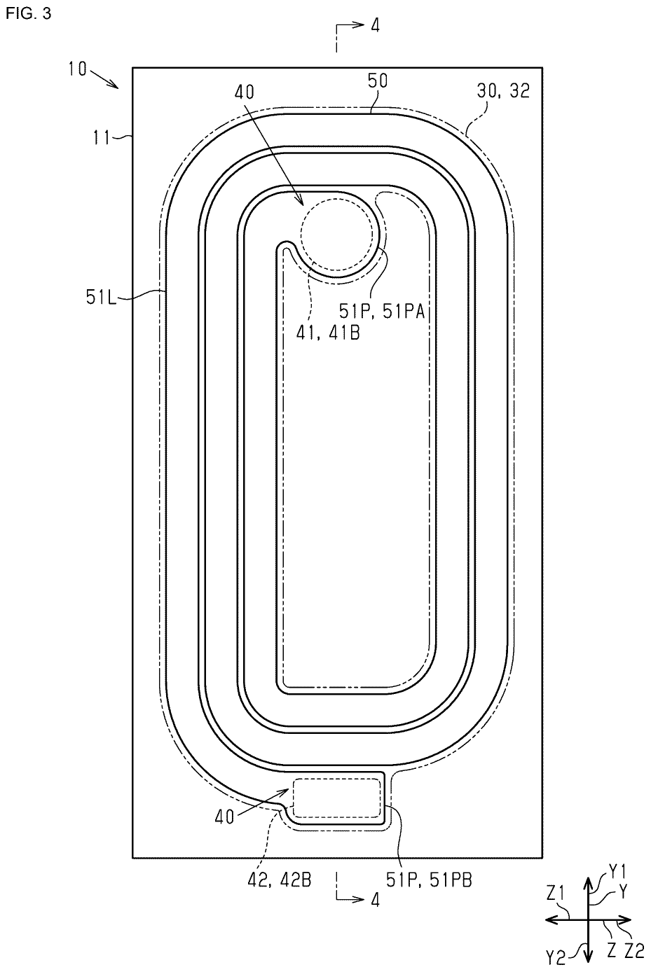

As illustrated in FIG. 3, the inductor conductor 50 extends parallel to the first main surface 11A and in a spiral shape. That is, the inductor conductor 50 is in the form of a line. As illustrated in FIG. 4, the inductor conductor 50 includes a seed layer 51A. The seed layer 51A constitutes a part of a surface of the inductor conductor 50 on the first negative direction X2 side. The material of the seed layer 51A is copper. By performing electrolytic copper plating on the seed layer 51A, copper grows on the seed layer 51A, and the entirety of the inductor conductor 50 is formed.

As illustrated in FIG. 3, the inductor conductor 50 includes a pair of pad portions 51P and a conductor body 51L. The pair of pad portions 51P are located at both end portions of the inductor conductor 50. An inner pad portion 51PA is one of the pair of pad portions 51P. An outer pad portion 51PB is the other of the pair of pad portions 51P. In a transparent view in the first negative direction X2, the inner pad portion 51PA is located on the second positive direction Y1 side with respect to the geometric center of the element body 11. In a transparent view in the first negative direction X2, the inner pad portion 51PA has a substantially circular shape. The outer pad portion 51PB is located on the second negative direction Y2 side with respect to the geometric center of the element body 11. In a transparent view in the first negative direction X2, the outer pad portion 51PB has a substantially quadrangular shape.

The conductor body 51L connects the pair of pad portions 51P. To be specific, in a transparent view of the element body 11 in the first negative direction X2, the conductor body 51L extends counterclockwise from the inner pad portion 51PA toward the outer pad portion 51PB in such a way that the diameter thereof increases as the number of turns increases. The number of turns of the inductor conductor 50 is 2.5 turns.

The number of turns of the inductor conductor 50 is defined based on an imaginary vector. The initial point of the imaginary vector is disposed on the center line of the inductor conductor 50. The number of turns is defined to be 1.0 turn when the rotation angle of the direction of the imaginary vector becomes 360 degrees while the initial point of the imaginary vector is moved from a first end to a second end of the center line in a transparent view in the first negative direction X2. In a case where the direction of the imaginary vector rotates a plurality of times, it is defined that the number of turns increases when turns in the same direction continue.

The center line of the inductor conductor 50 is defined as follows. In a transparent view in the first negative direction X2, a line segment that is the shortest of line segments that can be drawn from any point on an edge of the inductor conductor 50 to an edge on the opposite side is specified. The center line of the inductor conductor 50 is a line connecting the centers of the specified line segments in a transparent view in the first negative direction X2.

As illustrated in FIG. 4, the inductor component 10 includes, as insulation layers 30, a first interlayer insulation layer 31, an inter-conductor insulation layer 32, and a second interlayer insulation layer 33.

The first interlayer insulation layer 31 has a flat-plate-like shape. The first interlayer insulation layer 31 extends in the element body 11 parallel to the first main surface 11A. The first interlayer insulation layer 31 is in contact with a surface of the first magnetic layer 21 on the first positive direction X1 side. The first interlayer insulation layer 31 is in contact with a surface of the inductor conductor 50 on the first negative direction X2 side. In other words, the inductor conductor 50 extends on the first positive direction X1 side with respect to the first interlayer insulation layer 31. Accordingly, the first interlayer insulation layer 31 is located at the same position as the first interlayer magnetic layer 22 in the first positive direction X1.

The second interlayer insulation layer 33 has a flat-plate-like shape. The second interlayer insulation layer 33 extends in the element body 11 parallel to the first main surface 11A. The second interlayer insulation layer 33 is in contact with a surface of the inductor conductor 50 on the first positive direction X1 side. The second interlayer insulation layer 33 is in contact with a surface of the third magnetic layer 25 on the first negative direction X2 side. Accordingly, the second interlayer insulation layer 33 is located at the same position as the second interlayer magnetic layer 24 in the first positive direction X1.

When a side surface of the inductor conductor 50 is defined as a surface of the inductor conductor 50 facing in a direction parallel to the first main surface 11A, the inter-conductor insulation layer 32 covers the side surface of the inductor conductor 50. Accordingly, the inter-conductor insulation layer 32 has a portion that is located at the same position as the inductor conductor 50 in the first positive direction X1. In other words, the inductor conductor 50 has a portion that is adjacent to the inter-conductor insulation layer 32 in the direction parallel to the first main surface 11A. The inter-conductor insulation layer 32 extends through the second interlayer insulation layer 33. Accordingly, the inter-conductor insulation layer 32 has a portion that is located at the same position as the second interlayer insulation layer 33 and the second interlayer magnetic layer 24 in the first positive direction X1. In a specific cross section perpendicular to the center line of the inductor conductor 50, the inter-conductor insulation layer 32 includes a plurality of portions that are discontinuous in a direction along the first main surface 11A. For example, in a specific cross section illustrated in FIG. 4, the inter-conductor insulation layer 32 includes eight portions that are discontinuous in the direction along the first main surface 11A.

Here, in the specific cross section, an outer insulation layer 32A is a portion of the inter-conductor insulation layer 32 whose surface facing in a direction parallel to the first main surface 11A is in contact with the element body 11. In the specific cross section, an inner insulation layer 32B is a portion of the inter-conductor insulation layer 32 whose surface facing in a direction parallel to the first main surface 11A is not in contact with the element body 11. For example, four outer insulation layers 32A are present in the specific cross section illustrated in FIG. 4. Four inner insulation layers 32B are present in the specific cross section. To be specific, in the specific cross section, two outer insulation layers 32A are located on the second positive direction Y1 side with respect to the geometric center of the element body 11, and two inner insulation layers 32B are located between the outer insulation layers 32A. The inductor conductor 50 is located between these portions of the inter-conductor insulation layer 32. Moreover, two outer insulation layers 32A are located on the second negative direction Y2 side with respect to the geometric center of the element body 11, and two inner insulation layers 32B are located between the outer insulation layers 32A. The inductor conductor 50 is located between these portions of the inter-conductor insulation layer 32. That is, the inductor conductor 50 extends on the first positive direction X1 side with respect to the first interlayer insulation layer 31 in a region partitioned by these portions of the inter-conductor insulation layer 32.

As illustrated in FIG. 2, the inductor component 10 includes two columnar conductors 40 and two outer electrodes 60. Each columnar conductor 40 extends in a direction intersecting the first main surface 11A. In the present embodiment, each columnar conductor 40 extends in a direction perpendicular to the first main surface 11A. Each columnar conductor 40 is located on the first positive direction X1 side with respect to the inductor conductor 50. Each columnar conductor 40 is electrically connected to the inductor conductor 50.

To be specific, a first columnar conductor 41, which is one of the two columnar conductors 40, is composed of a first via 41A and a first extension conductor 41B. The material of the first columnar conductor 41 is the same as the material of the inductor conductor 50. The first via 41A has a substantially cylindrical shape. As illustrated in FIG. 4, the first via 41A extends through the second interlayer insulation layer 33. Accordingly, the first via 41A is located at the same position as the second interlayer insulation layer 33 and the second interlayer magnetic layer 24 in the first positive direction X1. A surface of the first via 41A facing toward the first negative direction X2 side is connected to the inner pad portion 51PA of the inductor conductor 50.

As illustrated in FIG. 3, the first extension conductor 41B has a substantially cylindrical shape. As illustrated in FIG. 2, the diameter of the first extension conductor 41B is slightly larger than the diameter of the first via 41A. A surface of the first extension conductor 41B facing toward the first negative direction X2 side is connected to the first via 41A. Accordingly, the first extension conductor 41B is located at the same position as the third magnetic layer 25 in the first positive direction X1. A surface of the first extension conductor 41B on the first positive direction X1 side is exposed from the first main surface 11A.

As illustrated in FIG. 2, a second columnar conductor 42, which is the other of the two columnar conductors 40, is composed of a second via 42A and a second extension conductor 42B. The material of the second columnar conductor 42 is the same as the material of the inductor conductor 50. The second columnar conductor 42 is located on the second negative direction Y2 side with respect to the first columnar conductor 41. The second via 42A has a substantially quadrangular prismatic shape. The second via 42A extends through the second interlayer insulation layer 33. Accordingly, the second via 42A is located at the same position as the second interlayer insulation layer 33 and the second interlayer magnetic layer 24 in the first positive direction X1. A surface of the second via 42A facing toward the first negative direction X2 side is connected to the outer pad portion 51PB of the inductor conductor 50.

As illustrated in FIG. 3, the second extension conductor 42B has a substantially quadrangular prismatic shape. As illustrated in FIG. 2, the dimension of each side of the second extension conductor 42B is slightly larger than the dimension of each side of the second via 42A. A surface of the second extension conductor 42B facing toward the first negative direction X2 side is connected to the second via 42A. Accordingly, the second extension conductor 42B is located at the same position as the third magnetic layer 25 in the first positive direction X1. A surface of the second extension conductor 42B on the first positive direction X1 side is exposed from the first main surface 11A.

As illustrated in FIG. 1, each outer electrode 60 is exposed from the element body 11. To be specific, each outer electrode 60 is located on the first main surface 11A of the element body 11. That is, each outer electrode 60 covers a part of the outer surface of the element body 11.

As illustrated in FIG. 2, a first outer electrode 61, which is one of the two outer electrodes 60, is located, on the first main surface 11A, on the second positive direction Y1 side with respect to the geometric center of the first main surface 11A. The first outer electrode 61 is in contact with a surface of the first extension conductor 41B facing in the first positive direction X1. A second outer electrode 62, which is the other of the two outer electrodes 60, is located, on the first main surface 11A, on the second negative direction Y2 side with respect to the geometric center of the first main surface 11A. The second outer electrode 62 is in contact with a surface of the second extension conductor 42B facing in the first positive direction X1.

The inductor component 10 includes a solder resist 70. The solder resist 70 covers a portion of a surface of the element body 11 facing in the first positive direction X1 excluding the two outer electrodes 60. That is, the first main surface 11A of the element body 11 is covered by the outer electrodes 60 and the solder resist 70 and is not exposed. The solder resist 70 has higher insulation than the element body 11.

### Inductor Conductor in Specific Section

As illustrated in FIG. 6, in a specific cross section, a conductor width W1 is defined as the shortest distance between the portions of the inter-conductor insulation layer 32. The conductor width W1 is the largest conductor width of the inductor conductor 50 in the direction along the first main surface 11A. In the specific cross section, a seed layer width W2 is defined as the largest dimension of the seed layer 51A, located between the portions of the inter-conductor insulation layer 32, in the same direction as the conductor width W1. The seed layer width W2 is greater than or equal to 40% and less than or equal to 90% (i.e., from 40% to 90%) of the conductor width W1. That is, in the specific cross section illustrated in FIG. 6, the dimension of the seed layer 51A in the direction along the second axis Y is shorter than the distance between adjacent portions of the inter-conductor insulation layer 32.

As illustrated in FIG. 6, corner portions CB, which are located on the first positive direction X1 side of the inductor conductor 50 and outside in the direction along the second axis Y, are rounded. That is, both corner portions CB of the inductor conductor 50 on the first positive direction X1 side each have a roundly chamfered shape. A central portion CA of an end surface the inductor conductor 50 in the first positive direction X1 has a flat shape substantially perpendicular to the first axis X. That is, in the specific cross section, the end surface of the inductor conductor 50 in the first positive direction X1 is composed of the central portion CA and the two rounded corner portions CB. In the present embodiment, the dimension H1 of the corner portion CB in the direction along the first axis X is about 10 μm. The dimension H2 of the corner portion CB in the direction along the second axis Y is about 25 μm.

### Insulation Layer

Hereafter, the configurations of the first interlayer insulation layer 31 and the inter-conductor insulation layer 32 will be described. The second interlayer insulation layer 33 has a configuration similar to that of the first interlayer insulation layer 31. Therefore, only the first interlayer insulation layer 31 will be described.

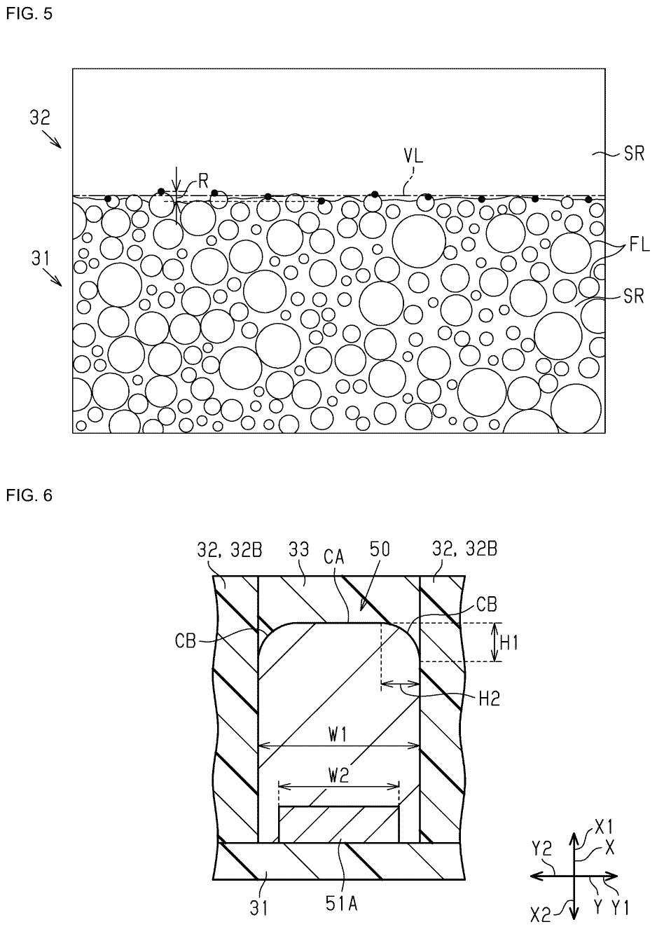

As illustrated in FIG. 5, the first interlayer insulation layer 31 includes a synthetic resin SR having insulating properties and a plurality of fillers FL dispersed in the synthetic resin SR. Here, “dispersed” means that the fillers FL are located randomly in the synthetic resin SR. Accordingly, even if some of the fillers FL are agglomerated, the fillers FL are said to be dispersed as along as the arrangement of the fillers FL is random. In FIG. 5, only some of the fillers FL are indicated by symbols.

In the present embodiment, the synthetic resin SR is polyimide-based resin. The volume percentage of the synthetic resin SR in the first interlayer insulation layer 31 is greater than or equal to 40 vol % and less than or equal to 70 vol % (i.e., from 40 vol % to 70 vol %). The volume percentage of the synthetic resin SR in the first interlayer insulation layer 31 is calculated, for example, as follows. First, by using a scanning electron microscope (SEM), a 500 nm square region in a cross-section of the first interlayer insulation layer 31 is observed. In this region, the total area of portions where the fillers FL are not present, that is, total area of the synthetic resin SR, is calculated by image processing. Then, an area percentage is calculated from the ratio of the total area of the synthetic resin SR to the area of the observed region. This step is repeated three times or more for different cross sections of the first interlayer insulation layer 31, and the area percentage for each region is calculated. Then, the average value of the calculated area percentages is calculated, and this calculation result is defined as the volume percentage.

The fillers FL are nonmagnetic insulating inorganic compound. In the present embodiment, the fillers FL are silica. That is, in the present embodiment, the plurality of fillers FL are nonmagnetic inorganic oxide.

In the particle size distribution of the fillers FL, the median diameter (D50) is greater than or equal to 0.1 μm and less than or equal to 5 μm (i.e., from 0.1 μm to 5 μm). The median diameter (D50) of the fillers FL is calculated, for example, as follows. First, a particle size distribution is acquired by sampling the fillers FL by using a scanning electron microscope. Next, in the particle size distribution, for particle diameters in the range from the smallest particle diameter to the largest particle diameter, the frequencies of the particle diameters are accumulated. The median diameter (D50) is a particle diameter where the accumulated value becomes 50%.

The particle diameters of the fillers FL are measured, for example, as follows. First, an image of a specific cross section is captured by using a scanning electron microscope. The outlines of the fillers FL in the image are acquired by image processing. Then, the area of one filler FL is calculated. A circle having the calculated area is assumed. The diameter of the circle is calculated as the particle diameter of the filler FL.

One selected from the reflectance for the g-line, the reflectance for the h-line, and the reflectance for the i-line of the first interlayer insulation layer 31 is less than or equal to 80%. In the present embodiment, all of the reflectance for the g-line, the reflectance for the h-line, and the reflectance for the i-line of the first interlayer insulation layer 31 having a thickness of 10 μm are less than or equal to 80%. The wavelength of the g-line is 436 nm. The wavelength of the h-line is 405 nm. The wavelength of the i-line is 365 nm.

The reflectance is measured, for example, as follows. First, a measurement sample in which the first interlayer insulation layer 31 having a thickness of 10μ is formed on a silicon substrate is made. Next, the g-line is emitted toward the measurement sample from the thickness direction of the sample. Next, reflected light from the measurement sample is measured by using a photoreceiver. Then, the ratio of the intensity of the reflected light measured by the photoreceiver to the intensity of the incident light of the emitted g-line is measured as the reflectance. The reflectance for each of the h-line and the i-line is measured in the same way.

The maximum roughness R of a surface of the first interlayer insulation layer 31 is greater than or equal to 0.05 μm and less than or equal to 1 μm (i.e., from 0.05 μm to 1 μm). That is, the maximum roughness R of a surface of the first interlayer insulation layer 31 facing in the first positive direction X1 is greater than or equal to 0.05 μm and less than or equal to 1 μm (i.e., from 0.05 μm to 1 μm). The maximum roughness R is calculated, for example, as follows. First, by using a scanning electron microscope, a cross-section including the first interlayer insulation layer 31 is observed in a region such that the surface of the first interlayer insulation layer 31 has a span of greater than or equal to 100 μm. Next, in a direction along the surface of the first interlayer insulation layer 31, points at 10 μm intervals on the surface of the first interlayer insulation layer 31 are specified. Then, for ten specified points, an approximate straight line VL for which difference is the smallest is assumed. The approximate straight line VL is calculated, for example, by using the least square method. The maximum roughness R is the distance, in a direction perpendicular to the approximate straight line VL, between the outermost point and the innermost point on the surface of the first interlayer insulation layer 31.

The inter-conductor insulation layer 32 includes a synthetic resin SR having insulting properties and does not include the fillers FL. In the present embodiment, the material of the synthetic resin SR of the inter-conductor insulation layer 32 is the same as the material of the synthetic resin SR of the first interlayer insulation layer 31. That is, the material of the synthetic resin SR of the inter-conductor insulation layer 32 is polyimide-based resin,

The visible light transmittance of the inter-conductor insulation layer 32 per 20 μm distance is greater than or equal to 70%. The visible light transmittance of the first interlayer insulation layer 31 per 20 μm distance is less than or equal to 50%. Here, the visible light transmittance is a transmittance in the entirety of the wavelength range of greater than or equal to 400 nm and less than or equal to 800 nm (i.e., from 400 nm to 800 nm). Accordingly, for example, even if the transmittance in a specific wavelength band in the above range is less than 70%, the transmittance in the entirety may be greater than or equal to 70%.

The transmittance of the inter-conductor insulation layer 32 is measured, for example, as follows. First, the inter-conductor insulation layer 32 having a predetermined thickness is prepared. The thickness is preferably about 20μm. Then, visible light is emitted toward the inter-conductor insulation layer 32 in the thickness direction of the inter-conductor insulation layer 32. Then, by using a photoreceiver, visible light that has passed through the inter-conductor insulation layer 32 is measured from a direction opposite to the direction from which visible light is emitted toward the inter-conductor insulation layer 32. Then, the ratio of the intensity of the transmitted light, measured by the photoreceiver, to the intensity of emitted incident light is calculated. The visible light transmittance is the calculation result converted to a transmittance per 20 μm. The visible light transmittance of the first interlayer insulation layer 31 can be calculated in the same way.

### Manufacturing Method

Next, a method of manufacturing the inductor component 10 will be described.

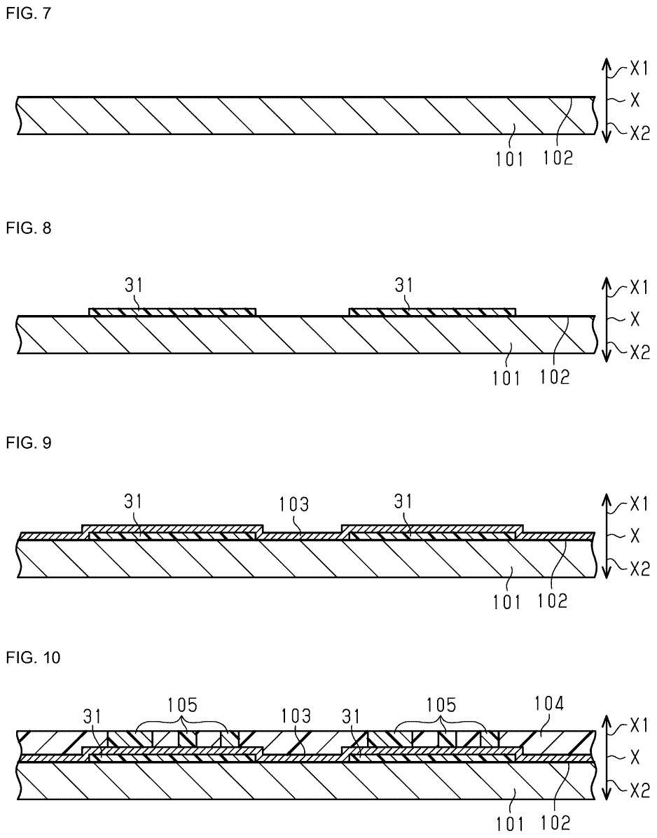

As illustrated in FIG. 7, first, a base preparing step is performed. To be specific, a base member 101 having a plate-like shape is prepared. The material of the base member 101 is ceramic. The base member 101 has a quadrangular shape when seen in the first negative direction X2. The dimension of each side of the base member 101 is a dimension with which the base member 101 can hold a plurality of inductor components 10. Next, a dummy insulation layer 102 is applied to the entirety of a surface of the base member 101 on the first positive direction X1 side, that is, the upper surface. In FIG. 7, the dummy insulation layer 102 is shown by a thick line.

Next, as illustrated in FIG. 8, a first insulation-layer processing step of forming the first interlayer insulation layer 31 is performed. The first interlayer insulation layer 31 is formed on the surface of the base member 101 on the first positive direction X1 side. To be specific, the first interlayer insulation layer 31 is patterned. Patterning is performed over an area that is slightly larger than an area in which the inductor conductor 50 is to be disposed. To be specific, the first interlayer insulation layer 31, including the fillers FL and the synthetic resin SR, is formed by photolithography.

Next, as illustrated in FIG. 9, a seed forming step of forming the seed layer 51A is performed. To be specific, by performing sputtering, a seed portion 103 of copper is formed on surfaces of the first interlayer insulation layer 31 and the dummy insulation layer 102 on the first positive direction X1 side.

Next, as illustrated in FIG. 10, the upper surface of the seed portion 103 is laminated with a resist 104 that is photosensitive. Then, only a region of the upper surface of the seed portion 103 on which the seed layer 51A of the inductor conductor 50 is to be formed is exposed to light. A portion of the resist 104 exposed to light hardens. This hardened portion is formed as a covering portion 105. Subsequently, an unhardened portion of the resist 104, that is, a portion other than the covering portion 105, is removed.

Next, as illustrated in FIG. 11, the seed portion 103 is etched. Thus, the seed portion 103 exposed from the covering portion 105 is removed.

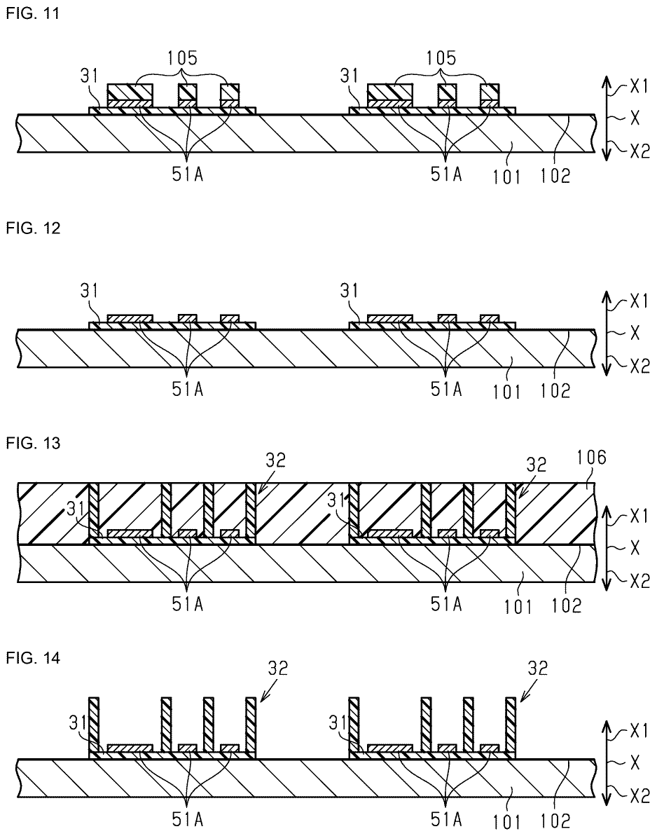

Then, as illustrated in FIG. 12, the covering portion 105 is wet-etched by using a chemical. Thus, the covering portion 105 peels off. As a result, the seed layer 51A is formed.

Subsequently, as illustrated in FIG. 13, a second insulation-layer processing step of forming the inter-conductor insulation layer 32 is performed. To be specific, first, surfaces of the dummy insulation layer 102, the seed layer 51A, and the first interlayer insulation layer 31 on the first positive direction X1 side are laminated with a permanent resist 106 that is photosensitive. Next, a region where the inter-conductor insulation layer 32 is to be formed, that is, a region located on both sides of the seed layer 51A is exposed to light. To be specific, a partial region of the surface of the first interlayer insulation layer 31 on the first positive direction X1 side is exposed to light.

Next, as illustrated in FIG. 14, an unhardened portion of the permanent resist 106 is peeled off and removed by using a chemical. Thus, the inter-conductor insulation layer 32 is formed. The permanent resist 106 is composed of only the synthetic resin SR.

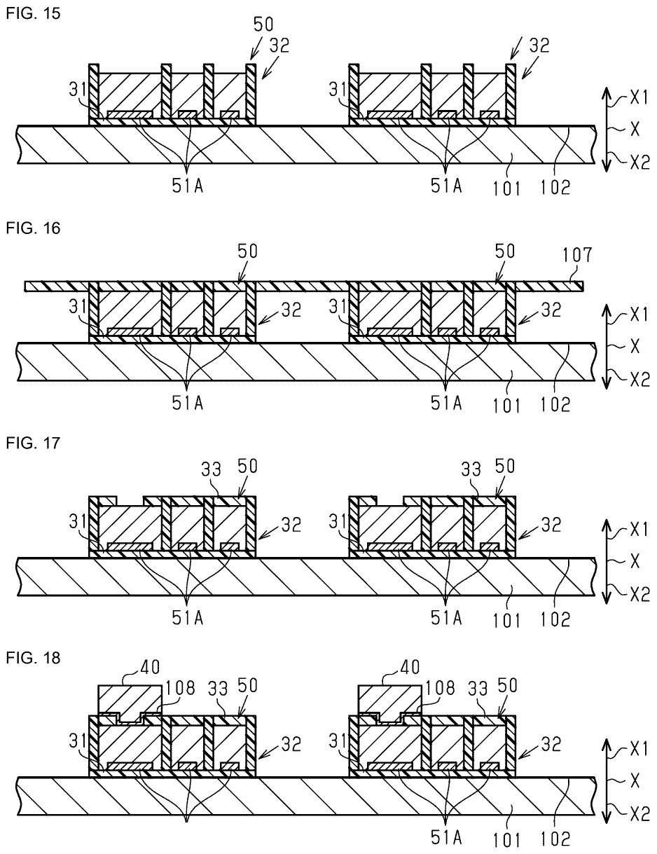

Next, as illustrated in FIG. 15, a first conductor forming step of forming the inductor conductor 50 is performed. To be specific, by performing electrolytic copper plating, copper is grown on the surface of the first interlayer insulation layer 31 on the first positive direction X1 side from a portion where the seed layer 51A is exposed. Thus, the inductor conductor 50 is formed. An end of the inductor conductor 50 in the first positive direction X1 is located on the first negative direction X2 side with respect to an end of the inter-conductor insulation layer 32 on the first positive direction X1 side. In the process in which growth of copper plating on the seed layer 51A accelerates, a rounded corner portion CB may be formed on the first positive direction X1 side of the inductor conductor 50.

Next, as illustrated in FIG. 16, a third insulation-layer processing step of forming the second interlayer insulation layer 33 is performed. First, a surface of the inductor conductor 50 on the first positive direction X1 side is laminated to be covered with a permanent resist 107 that is photosensitive. The permanent resist 107 includes the fillers FL and the synthetic resin SR.

Next, as illustrated in FIG. 17, a portion of the surface the inductor conductor 50 on the first positive direction X1 side, excluding a portion where the first via 41A and the second via 42A are to be formed, is exposed to light. As the portion exposed to light hardens, the second interlayer insulation layer 33 is formed. The dimension of the second interlayer insulation layer 33 in the direction along the first axis X is substantially the same as the dimension of the first interlayer insulation layer 31 in the direction along the first axis X.

Next, as illustrated in FIG. 18, a second conductor forming step of forming the columnar conductor 40 is performed. A region where the columnar conductor 40 is to be formed is a portion including a region where the inductor conductor 50 is exposed from the second interlayer insulation layer 33. First, a columnar seed layer 108 is formed in the region in the same way as in the seed forming step described above. In FIGS. 2 to 4, illustration of the columnar seed layer 108 is omitted. Then, a resist is formed in a portion outside of the region described above by performing photolithography in the same way as in the first insulation-layer processing step. Then, the columnar conductor 40 is formed by copper plating by performing a step similar to the first conductor forming step. Subsequently, the resist is removed. As a result, the first columnar conductor 41 and the second columnar conductor 42 are formed.

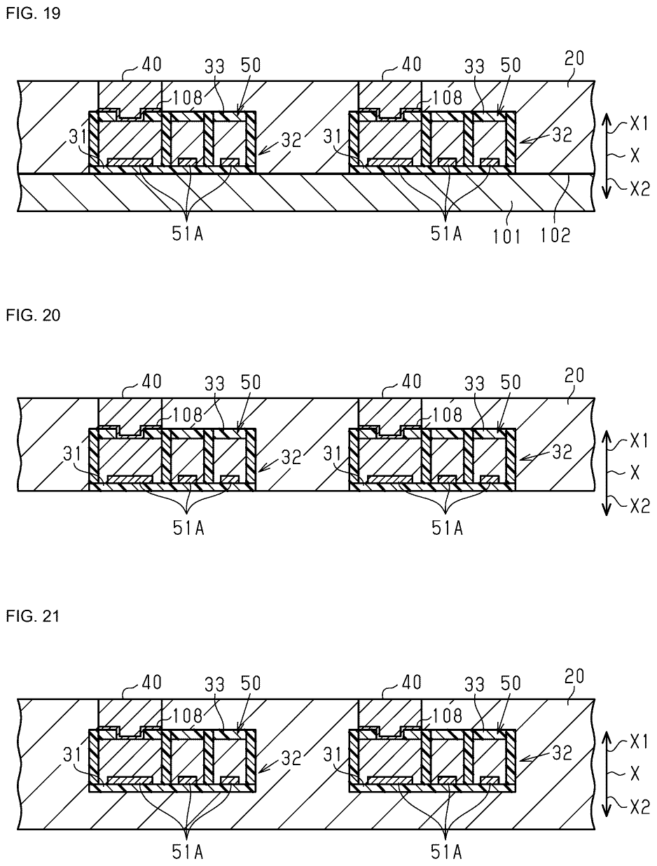

Next, as illustrated in FIG. 19, a first magnetic-body forming step of forming the magnetic layers 20 other than the first magnetic layer 21 is performed. First, a resin including magnetic powder, which is the material of the magnetic layer 20, is applied to the first positive direction X1 side with respect to the dummy insulation layer 102. At this time, the resin including magnetic powder is applied to cover also a surface of each columnar conductor 40 on the first positive direction X1 side. Next, by hardening the resin including magnetic powder by performing press working, the first interlayer magnetic layer 22, the second magnetic layer 23, the second interlayer magnetic layer 24, and the third magnetic layer 25 are formed on the surface of the dummy insulation layer 102 on the first positive direction X1 side.

Then, a portion of the third magnetic layer 25 on the first positive direction X1 side is ground until the surface of each columnar conductor 40 on the first positive direction X1 side becomes exposed. In FIG. 19, the first interlayer magnetic layer 22, the second magnetic layer 23, the second interlayer magnetic layer 24, and the third magnetic layer 25 are illustrated as the magnetic layer 20 without distinction.

Next, as illustrated in FIG. 20, a base member cutting step is performed. To be specific, the base member 101 and the dummy insulation layer 102 are all removed by cutting. The inductor conductor 50 is not removed, although a part of the first interlayer insulation layer 31 on the first negative direction X2 side may be removed as a result of cutting all of the base member 101 and the dummy insulation layer 102.

Next, as illustrated in FIG. 21, a second magnetic-body forming step of forming the first magnetic layer 21 is performed. To be specific, first, a resin including magnetic powder, which is the material of the first magnetic layer 21, is applied to surfaces of the first interlayer insulation layer 31 and the first interlayer magnetic layer 22 on the first negative direction X2 side. Then, the resin including magnetic powder is hardened by performing press working. Subsequently, a portion of the resin on the first negative direction X2 side is ground. For example, a portion of the resin on the first negative direction X2 side is ground so that the dimension of the inductor component 10 along the first axis X has a desirable value. Thus, the first magnetic layer 21 is formed on the surfaces of the first interlayer insulation layer 31 and the first interlayer magnetic layer 22 on the first negative direction X2 side. In FIG. 21, the first magnetic layer 21, the first interlayer magnetic layer 22, the second magnetic layer 23, the second interlayer magnetic layer 24, and the third magnetic layer 25 are illustrated as the magnetic layer 20 without distinction.

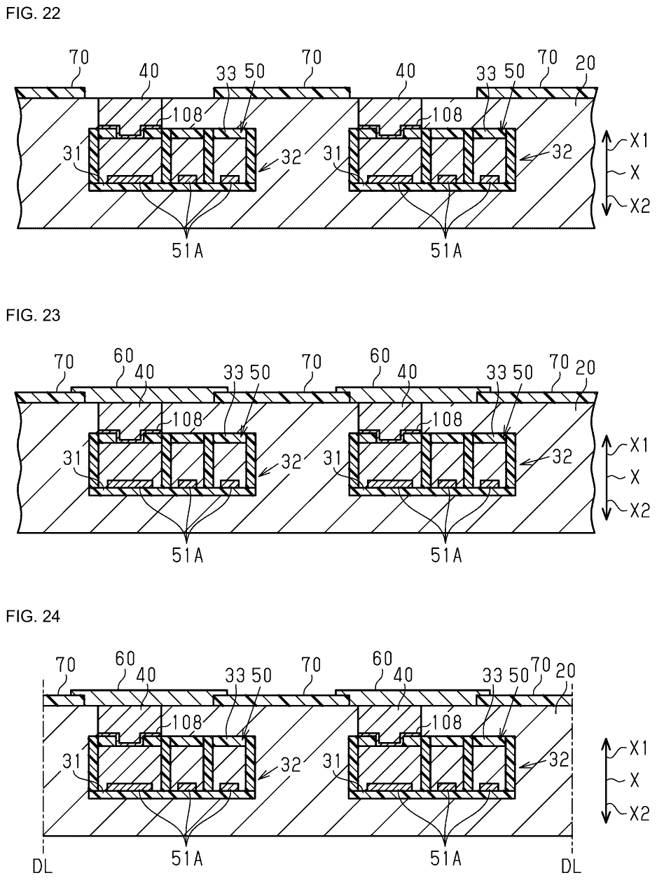

Next, as illustrated in FIG. 22, a main surface processing step of forming the solder resist 70 is performed. To be specific, an insulator is patterned on portions of a surface of the third magnetic layer 25 on the first positive direction X1 side and a surface of each columnar conductor 40 on the first positive direction X1 side on which each outer electrode 60 is not to be formed. Thus, the solder resist 70 is formed.

Next, as illustrated in FIG. 23, an electrode processing step of forming the outer electrode 60 is performed. A region in which the outer electrode 60 is to be formed is a region of each of a surface of the third magnetic layer 25 on the first positive direction X1 side and a surface of each columnar conductor 40 on the first positive direction X1 side that is not covered by the solder resist 70. Electroless plating of each of copper, nickel, and gold is performed on these regions. As a result, the first outer electrode 61 and the second outer electrode 62 are formed. In FIG. 23, layers of copper, nickel, and gold are illustrated without distinction. As illustrated in FIG. 23, a part of the outer electrode 60 may cover a part of a surface of the solder resist 70 on the first positive direction X1 side. Next, as illustrated in FIG. 24, a singulation step is performed. To be specific, singulation is performed by performing dicing along dividing lines DL. Thus, it is possible to obtain the inductor component 10.

### Visual Inspection

In the method of manufacturing the inductor component 10 described above, a sample after the inter-conductor insulation layer 32 had been formed on the first interlayer insulation layer 31 and before the inductor conductor 50 was formed was selected as a test sample. That is, a sample in the state illustrated in FIG. 14 was selected as the test sample. On the other hand, a sample after the inter-conductor insulation layer 32 had been formed on a first interlayer insulation layer that did not include the fillers FL and before the inductor conductor 50 was formed was selected as a comparative sample. That is, the test sample and the comparative sample were made on the same manufacturing conditions except for the presence/absence of the fillers in the first interlayer insulation layer. Then, for thirty-two test samples and thirty-two comparative samples, whether or not the inter-conductor insulation layer 32 had peeled off from the first interlayer insulation layer was visually inspected.

As a result, among the comparative samples, the percentage of inductor components in which peeling-off of the inter-conductor insulation layer 32 was detected was greater than or equal to 90%. On the other hand, among the test samples, the percentage of inductor components 10 in which peeling-off of the inter-conductor insulation layer 32 was detected was 0%. That is, it was found that adhesion of the inter-conductor insulation layer 32 to the first interlayer insulation layer 31 is stronger in a case where the first interlayer insulation layer 31 includes the fillers FL than in a case where the first interlayer insulation layer 31 does not include the fillers FL.

### Measurement of Amount of Curvature

Ten sample pieces were made, and the amount of curvature of each sample piece was measured. Each sample piece was made by forming the first interlayer insulation layer 31 having a thickness of 100 μm on the base member 101 having a diameter of 6 inches, performing UV curing, and then performing heat curing by using an oven or the like. Each sample was cooled until the temperature of the sample became the room temperature, and then the amount of curvature of each sample was measured. The amount of curvature of the sample piece was measured by using a laser displacement gauge. The base member 101 used here is the same as the base member 101 in the manufacturing method described above. For each sample piece, the volume percentage of the synthetic resin SR in the first interlayer insulation layer 31 was changed. To be specific, ten sample pieces were made while changing the volume percentage of the synthetic resin SR in the first interlayer insulation layer 31 by 10 vol % in the range of greater than or equal to 10 vol % and less than or equal to 100 vol % (i.e., from 10 vol % to 100 vol %). The constituent component of the first interlayer insulation layer 31 other than the synthetic resin SR was the fillers FL.

In sample pieces whose volume percentage of the synthetic resin SR in the first interlayer insulation layer 31 was 10 vol %, 20 vol %, 30 vol %, and 40 vol %, the amount of curvature of the sample pieces was in the range of about several micrometers to several tens of micrometers. When the volume percentage was in the range of 10 to 40 vol %, the ratio of increase in curvature did not change considerably. Here, “the ratio of increase in curvature” refers to the amount of increase in curvature when the volume percentage changes by a unit amount.

The amount of curvature of a sample piece increased as the volume percentage of the synthetic resin SR in the first interlayer insulation layer 31 became greater than 40 vol %. To be specific, the amount of curvature of a sample piece whose volume percentage of the synthetic resin SR in the first interlayer insulation layer 31 was 50 vol % was about 20 μm. The amount of curvature of a sample piece whose volume percentage of the synthetic resin SR in the first interlayer insulation layer 31 was 60 vol % was about 50 μm. The amount of curvature of a sample piece whose volume percentage of the synthetic resin SR in the first interlayer insulation layer 31 was 70 vol % was about 80 μm. The amount of curvature of a sample piece whose volume percentage of the synthetic resin SR in the first interlayer insulation layer 31 was 80 vol % was about 140 μm. The amount of curvature of a sample piece whose volume percentage of the synthetic resin SR in the first interlayer insulation layer 31 was 90 vol % was about 200 μm. The amount of curvature of a sample piece whose volume percentage of the synthetic resin SR in the first interlayer insulation layer 31 was 100 vol % was about 260 μm.

In this way, the ratio of increase in the amount of curvature increased as the volume percentage of the synthetic resin SR increased. In particular, the ratio of increase in curvature increased acceleratingly in a region where the volume percentage exceeded 70%. In the sample piece whose volume percentage of the synthetic resin SR in the first interlayer insulation layer 31 was 80 vol %, the amount of curvature was greater than or equal to the thickness of the first interlayer insulation layer 31 in the sample piece. Accordingly, it was found that it is preferable that the volume percentage of the synthetic resin SR in the first interlayer insulation layer 31 be less than or equal to 70 vol %. In the sample piece whose volume percentage of the synthetic resin SR in the first interlayer insulation layer 31 was 60 vol %, the amount of curvature was about a half of the thickness of the first interlayer insulation layer 31 in the sample piece. Accordingly, it was found that it is more preferable that the volume percentage of the synthetic resin SR in the first interlayer insulation layer 31 be less than or equal to 60 vol %.

### Advantage Effects of Present Embodiment

(1) In the embodiment described above, the first interlayer insulation layer 31 includes the synthetic resin SR having insulating properties and the plurality of fillers FL dispersed in the synthetic resin SR. With this configuration, compared with a case where the first interlayer insulation layer 31 is composed of only the synthetic resin, deformation of the first interlayer insulation layer 31 due to heat can be suppressed. Therefore, with this configuration, it is possible to suppress curving of the inductor component 10 while suppressing increase in the dimensions of the inductor component 10 due to deformation of the first interlayer insulation layer 31. In this respect, the second interlayer insulation layer 33 provides a similar advantageous effect.
(2) The inter-conductor insulation layer 32 extends from the first interlayer insulation layer 31 in the first positive direction X1. Therefore, when the inter-conductor insulation layer 32 is to be formed by photolithography, it is preferable that the sensitivity of the inter-conductor insulation layer 32 to light exposure amount be higher. In the embodiment described above, the inter-conductor insulation layer 32 does not include the fillers FL. Because the inter-conductor insulation layer 32 does not include the fillers FL in this way, it is possible to suppress decrease of the sensitivity of the inter-conductor insulation layer 32 to light exposure amount due to the presence of the fillers FL.
(3) When fillers FL whose median diameter (D50) is greater than 5 μm were used, depending on the shape of a portion where the first interlayer insulation layer 31 is formed, the fillers FL might collide with each other and a portion that is not filled with the fillers FL might be generated. When fillers FL whose median diameter (D50) is less than 0.1 μm were used, the specific surface area of each filler FL with respect to the synthetic resin SR would increase. Thus, the viscosity of the first interlayer insulation layer 31 would decrease. As a result, the distribution of the fillers FL in the synthetic resin SR might become nonuniform. In the embodiment described above, in the particle size distribution of the fillers FL, the median diameter (D50) is greater than or equal to 0.1 μm and less than or equal to 5 μm (i.e., from 0.1 μm to 5 μm). This range of median diameter (D50) is preferable, because the fillers FL are distributed uniformly when the first interlayer insulation layer 31 is formed.
(4) In the embodiment described above, the dimension H1 of the corner portion CB of the inductor conductor 50 in the direction along the first axis X is about 10 μm. The dimension H2 of the corner portion CB in the direction along the second axis Y is about 25 μm. As with the first interlayer insulation layer 31, the second interlayer insulation layer 33 includes the fillers FL. When the median diameter (D50) is in the range of the embodiment described above, the second interlayer insulation layer 33, which is located on the first positive direction X1 side of the inductor conductor 50, can be easily filled with the fillers FL along the corner portion CB.
(5) In the embodiment described above, the visible light transmittance of the inter-conductor insulation layer 32 per 20 μm distance is greater than or equal to 70%. The visible light transmittance of the first interlayer insulation layer 31 per 20 μm distance is less than or equal to 50%. For example, in the first interlayer insulation layer 31 and the inter-conductor insulation layer 32, a phenomenon that influences the appearance of a product without influencing the characteristics of the product, such as a micro-void, may occur in the manufacturing process. When the visible light transmittance of the first interlayer insulation layer 31 and the inter-conductor insulation layer 32 is in the range of the embodiment described above, it is possible to ensure the accuracy of visual inspection using visible light in the manufacturing process. Moreover, when the visible light transmittance of the first interlayer insulation layer 31 and the inter-conductor insulation layer 32 is in the range of the embodiment described above, it is possible to check the surface of the inductor conductor 50 through the first interlayer insulation layer 31 and the inter-conductor insulation layer 32. That is, with the configuration of the embodiment described above, it is possible to visually inspect the inductor conductor 50. In this respect, the second interlayer insulation layer 33 provides a similar advantageous effect.
(6) In the embodiment described above, the volume percentage of the synthetic resin SR in the first interlayer insulation layer 31 is greater than or equal to 40 vol % and less than or equal to 70 vol % (i.e., from 40 vol % to 70 vol %). If the amount of the synthetic resin SR in the first interlayer insulation layer 31 were too large, the effect of the fillers FL in reducing curving of the first interlayer insulation layer 31 would be weak. On the other hand, if the amount of the synthetic resin SR in the first interlayer insulation layer 31 were too small, the fluidity of the first interlayer insulation layer 31 while being formed would be reduced, and bubbles might be generated in the first interlayer insulation layer 31. When the volume percentage of the synthetic resin SR is in the range of the embodiment described above, it is possible to significantly reduce curving of the first interlayer insulation layer 31 while ensuring the fluidity of the first interlayer insulation layer 31. In this respect, the second interlayer insulation layer 33 provides a similar advantageous effect.
(7) When the inter-conductor insulation layer 32 is to be formed on the first interlayer insulation layer 31 by photolithography, if the reflectance of the first interlayer insulation layer 31 for ultraviolet rays were greater than 80%, the developability of the inter-conductor insulation layer 32 might decrease. From this viewpoint, it is preferable that the reflectance of the first interlayer insulation layer 31 for ultraviolet rays be less than or equal to 80%. As the reflectance of the first interlayer insulation layer 31 for ultraviolet rays decreases, hardening of the inter-conductor insulation layer 32 during manufacturing becomes further suppressed. As a result, the inter-conductor insulation layer 32 having a small width is formed. When the inter-conductor insulation layer 32 has a small width, correspondingly, it is possible increase the volume of the magnetic layer 20 and to increase the conductor width W1. In the embodiment described above, one or more selected from the reflectance for the g-line, the reflectance for the h-line, and the reflectance for the i-line of the first interlayer insulation layer 31 is less than or equal to 80%. Accordingly, with this configuration, it is easy to form the inter-conductor insulation layer 32 having a small width.
(8) In the embodiment described above, the maximum roughness R of a surface of the first interlayer insulation layer 31 facing in the first positive direction X1 is greater than or equal to 0.05 μm and less than or equal to 1 μm (i.e., from 0.05 μm to 1 μm). When the maximum roughness R is large, adhesion between the inter-conductor insulation layer 32 and the first interlayer insulation layer 31 improves due to the anchor effect. Likewise, when the maximum roughness R is large, adhesion between the inductor conductor 50 and the first interlayer insulation layer 31 improves. On the other hand, if the maximum roughness R were too large, electrical resistance might increase due to the skin effect of the inductor conductor 50. The maximum roughness R in the embodiment described above is preferable in obtaining the anchor effect with the inter-conductor insulation layer 32 while suppressing electrical resistance of the inductor conductor 50.

In particular, in the manufacturing process, the inductor conductor 50 might peel off from the first interlayer insulation layer 31 due to the difference in thermal expansion coefficient between the inductor conductor 50 and the first interlayer insulation layer 31. As adhesion between the first interlayer insulation layer 31 and the inductor conductor 50 improves, such peeling off can be suppressed and decrease of inductance value due to generation of a void can be suppressed. In this respect, the second interlayer insulation layer 33 provides a similar advantageous effect.
(9) In the embodiment described above, the seed layer width W2 is greater than or equal to 40% and less than or equal to 90% (i.e., from 40% to 90%) of the conductor width W1. If the percentage of the seed layer width W2 were too small, adhesion between the first interlayer insulation layer 31 and the seed layer 51A would be unlikely to be maintained. On the other hand, if the seed layer width W2 were too large, the risk of interference between the seed layer 51A and another member would increase. Accordingly, the percentage of the seed layer width W2 in the embodiment described above is preferable in reducing such a risk.

### Modifications

The embodiment described above and modifications described below can be combined unless technical contradiction occurs. Regarding a modification that can be applied to each of the first interlayer insulation layer 31 and the second interlayer insulation layer 33, a representative example in which the modification is applied to the first interlayer insulation layer 31 will be described.

In the embodiment described above, the inductor component 10 need not have the outer electrode 60. In this case, a portion of the columnar conductor 40 exposed from the first main surface 11A may be used as an electrode.

In the embodiment described above, each columnar conductor 40 need not extend in a direction perpendicular to the first main surface 11A, and may extend in a direction intersecting the first main surface 11A.

In the embodiment described above, the shape of each columnar conductor 40 in a transparent view in a direction perpendicular to the first main surface 11A is not limited to the example in the embodiment described above. For example, the shapes of all of the columnar conductors 40 in a transparent view in a direction perpendicular to the first main surface 11A may be the same.

In the embodiment described above, the number of turns and the shape of the inductor conductor 50 are not limited to those in the embodiment described above. For example, the inductor conductor 50 may be in the form of a straight line, whose number of turns is 0.

In the embodiment described above, a part of the inductor conductor 50 need not be covered by the insulation layer 30 and may be in contact with the magnetic layer 20.

In the embodiment described above, the inductor component 10 may include a plurality of inductor conductors 50. For example, the inductor component 10 may include an additional inductor conductor 50 on the first positive direction X1 side of the second interlayer insulation layer 33.

In the embodiment described above, the columnar conductor 40 may be located on the first negative direction X2 side with respect to the inductor conductor 50. Likewise, the outer electrode 60 may be exposed from the second main surface 11B. In other words, the mounting surface of the inductor component 10 may be the second main surface 11B.

In the embodiment described above, the median diameter (D50) may be less than 0.1 μm or may be greater than 5 μm in the particle size distribution of the fillers FL.

In the embodiment described above, the visible light transmittance of the inter-conductor insulation layer 32 per 20 μm distance may be less than 70%. The visible light transmittance of the first interlayer insulation layer 31 per 20 μm distance may be greater than 50%.

In the embodiment described above, the volume percentage of the synthetic resin SR in the first interlayer insulation layer 31 may be less than 40 vol %. As long as the first interlayer insulation layer 31 includes the fillers FL, the volume percentage of the synthetic resin SR may be greater than 70 vol %. In order to suppress curving of the first interlayer insulation layer 31 and to ensure fluidity of the first interlayer insulation layer 31, it is more preferable that the volume percentage of the synthetic resin SR in the first interlayer insulation layer 31 be greater than or equal to 50 vol % and less than or equal to 60 vol % (i.e., from 50 vol % to 60 vol %).

In the embodiment described above, the reflectance for the g-line, the reflectance for the h-line, and the reflectance for the i-line of the first interlayer insulation layer 31 each may be greater than 80%. For example, when the reflectance for the g-line of the first interlayer insulation layer 31 is greater than 80%, the shape of the inter-conductor insulation layer 32 formed on the first interlayer insulation layer 31 may have a wider width with decreasing distance from the first interlayer insulation layer 31. With such a shape, the contact area between the first interlayer insulation layer 31 and the inter-conductor insulation layer 32 increases. As a result, improvement of adhesion between the first interlayer insulation layer 31 and the inter-conductor insulation layer 32 can be expected.

In the embodiment described above, the maximum roughness R of a surface of the first interlayer insulation layer 31 facing in the first positive direction X1 may be less than 0.05 μm or may be greater than 1 μm.

In the embodiment described above, the seed layer width W2 may be less than 40% of the conductor width W1. As long as the seed layer width W2 is less than or equal to the conductor width W1, the seed layer width W2 may be greater than 90%. For example, the seed layer width W2 and the conductor width W1 may be substantially the same. When the seed layer width W2 and the conductor width W1 are substantially the same, the corner portion CB might not be formed in the inductor conductor 50, and the cross-sectional shape of the inductor conductor 50 may be substantially rectangular.

In the embodiment described above, the inter-conductor insulation layer 32 need not extend through the second interlayer insulation layer 33. For example, the first positive direction X1 side of the inter-conductor insulation layer 32 may be covered by the second interlayer insulation layer 33. That is, a surface of the inter-conductor insulation layer 32 on the first positive direction X1 side need not be exposed from the second interlayer insulation layer 33.

In the embodiment described above, the first positive direction X1 side of the inductor conductor 50 need not have the central portion CA in the specific cross section. That is, an end surface of the inductor conductor 50 on the first positive direction X1 side may be a curved surface that is convex in the first positive direction X1.

In the embodiment described above, as long as the synthetic resin SR has insulating properties, the material of the synthetic resin SR is not limited to the material in the embodiment described above. Likewise, the material of the fillers FL is not limited to the example in the embodiment described above. For example, the material of the fillers FL may be alumina, carbon black, or the like.

In the embodiment described above, the material of the base member 101 is not limited to the example in the embodiment described above. For example, the material of the base member 101 may be glass epoxy resin, glass, or the like.

In the conductor forming step in the embodiment described above, a dummy conductor connected to the inductor conductor 50 may be formed. For example, it is possible to use the dummy conductor as a conductor for feeding electricity for forming copper plating.

### Appendix

Technical ideas that can be derived from the embodiment and the modifications described above will be described below.
[1] An inductor component comprising an element body having a main surface; an interlayer insulation layer having a flat plate-like shape and extending parallel to the main surface in the element body; an inter-conductor insulation layer extending from the interlayer insulation layer in a first positive direction perpendicular to the main surface; and an inductor conductor that is in a form of a line, that includes a portion adjacent to the inter-conductor insulation layer in a direction parallel to the main surface, and that extends parallel to the main surface on the first positive direction side with respect to the interlayer insulation layer, wherein the interlayer insulation layer includes a synthetic resin having insulating properties and a plurality of fillers dispersed in the synthetic resin.
[2] The inductor component according to [1], wherein the inter-conductor insulation layer includes a synthetic resin having insulating properties and does not include the fillers.
[3] The inductor component according to [1] or [2], wherein the fillers are nonmagnetic inorganic oxide, and wherein, in a particle size distribution of the fillers, a median diameter (D50) is greater than or equal to 0.1 μm and less than or equal to 5 μm (i.e., from 0.1 μm to 5 μm).
[4] The inductor component according to any one of [1] to [3], wherein a volume percentage of the synthetic resin in the interlayer insulation layer is greater than or equal to 40 vol % and less than or equal to 70 vol % (i.e., from 40 vol % to 70 vol %).
[5] The inductor component according to any one of [1] to [4], wherein a visible light transmittance of the inter-conductor insulation layer per 20 μm distance is greater than or equal to 70%, and wherein a visible light transmittance of the interlayer insulation layer per 20μm distance is less than or equal to 50%.
[6] The inductor component according to any one of [1] to [5], wherein one or more selected from a reflectance for a g-line, a reflectance for an h-line, and a reflectance for an i-line of the interlayer insulation layer is less than or equal to 80%.
[7] The inductor component according to any one of [1] to [6], wherein a maximum roughness of a surface of the interlayer insulation layer facing in the first positive direction is greater than or equal to 0.05 μm and less than or equal to 1 μm (i.e., from 0.05 μm to 1 μm).
[8] The inductor component according to any one of [1] to [7], wherein the inductor conductor includes a seed layer that is in contact with a surface of the interlayer insulation layer facing in the first positive direction and that extends parallel to the main surface. wherein, in a specific cross section perpendicular to a center line of the inductor conductor, the inter-conductor insulation layer includes a plurality of portions that are discontinuous in a direction along the main surface, and wherein, in the specific cross section, when a conductor width is defined as a shortest distance between the portions of the inter-conductor insulation layer and a seed layer width is defined as a largest dimension of the seed layer located between the portions of the inter-conductor insulation layer in a same direction as the conductor width, the seed layer width is greater than or equal to 40% and less than or equal to 90% (i.e., from 40% to 90%) of the conductor width.

What is claimed is:

1. An inductor component comprising:
an element body having a main surface;
an interlayer insulation layer having a flat plate-like shape and extending parallel to the main surface in the element body;
an inter-conductor insulation layer extending from the interlayer insulation layer in a first positive direction perpendicular to the main surface; and
an inductor conductor that is in a line, that includes a portion adjacent to the inter-conductor insulation layer in a direction parallel to the main surface, and that extends parallel to the main surface on the first positive direction side with respect to the interlayer insulation layer,
wherein the interlayer insulation layer includes a synthetic resin having insulating properties and a plurality of fillers dispersed in the synthetic resin.

2. The inductor component according to claim 1, wherein
the inter-conductor insulation layer includes a synthetic resin having insulating properties and does not include the fillers.

3. The inductor component according to claim 1, wherein
the fillers are nonmagnetic inorganic oxide, and
in a particle size distribution of the fillers, a median diameter (D50) is from 0.1 μm to 5 μm.

4. The inductor component according to claim 1, wherein
a volume percentage of the synthetic resin in the interlayer insulation layer is from 40 vol % to 70 vol %.

5. The inductor component according to claim 1, wherein
a visible light transmittance of the inter-conductor insulation layer per 20 μm distance is greater than or equal to 70%, and
a visible light transmittance of the interlayer insulation layer per 20 μm distance is less than or equal to 50%.

6. The inductor component according to claim 1, wherein
one or more selected from a reflectance for a g-line, a reflectance for an h-line, and a reflectance for an i-line of the interlayer insulation layer is less than or equal to 80%.

7. The inductor component according to claim 1, wherein
a maximum roughness of a surface of the interlayer insulation layer facing in the first positive direction is from 0.05 μm to 1 μm.

8. The inductor component according to claim 1, wherein
the inductor conductor includes a seed layer that is in contact with a surface of the interlayer insulation layer facing in the first positive direction and that extends parallel to the main surface,
in a specific cross section perpendicular to a center line of the inductor conductor, the inter-conductor insulation layer includes a plurality of portions that are discontinuous in a direction along the main surface, and
in the specific cross section, when a conductor width is defined as a shortest distance between the portions of the inter-conductor insulation layer and a seed layer width is defined as a largest dimension of the seed layer located between the portions of the inter-conductor insulation layer in a same direction as the conductor width,
the seed layer width is from 40% to 90% of the conductor width.

9. The inductor component according to claim 2, wherein
the fillers are nonmagnetic inorganic oxide, and
in a particle size distribution of the fillers, a median diameter (D50) is from 0.1 μm to 5 μm.

10. The inductor component according to claim 2, wherein
a volume percentage of the synthetic resin in the interlayer insulation layer is from 40 vol % to 70 vol %.

11. The inductor component according to claim 3, wherein
a volume percentage of the synthetic resin in the interlayer insulation layer is from 40 vol % to 70 vol %.

12. The inductor component according to claim 2, wherein
a visible light transmittance of the inter-conductor insulation layer per 20 μm distance is greater than or equal to 70%, and
a visible light transmittance of the interlayer insulation layer per 20 μm distance is less than or equal to 50%.

13. The inductor component according to claim 3, wherein
a visible light transmittance of the inter-conductor insulation layer per 20 μm distance is greater than or equal to 70%, and
a visible light transmittance of the interlayer insulation layer per 20 μm distance is less than or equal to 50%.

14. The inductor component according to claim 4, wherein
a visible light transmittance of the inter-conductor insulation layer per 20 μm distance is greater than or equal to 70%, and
a visible light transmittance of the interlayer insulation layer per 20 μm distance is less than or equal to 50%.

15. The inductor component according to claim 2, wherein
one or more selected from a reflectance for a g-line, a reflectance for an h-line, and a reflectance for an i-line of the interlayer insulation layer is less than or equal to 80%.

16. The inductor component according to claim 3, wherein
one or more selected from a reflectance for a g-line, a reflectance for an h-line, and a reflectance for an i-line of the interlayer insulation layer is less than or equal to 80%.

17. The inductor component according to claim 2, wherein
a maximum roughness of a surface of the interlayer insulation layer facing in the first positive direction is from 0.05 μm to 1 μm.

18. The inductor component according to claim 3, wherein
a maximum roughness of a surface of the interlayer insulation layer facing in the first positive direction is from 0.05 μm to 1 μm.

19. The inductor component according to claim 2, wherein
the inductor conductor includes a seed layer that is in contact with a surface of the interlayer insulation layer facing in the first positive direction and that extends parallel to the main surface,
in a specific cross section perpendicular to a center line of the inductor conductor, the inter-conductor insulation layer includes a plurality of portions that are discontinuous in a direction along the main surface, and
in the specific cross section, when a conductor width is defined as a shortest distance between the portions of the inter-conductor insulation layer and a seed layer width is defined as a largest dimension of the seed layer located between the portions of the inter-conductor insulation layer in a same direction as the conductor width,
the seed layer width is from 40% to 90% of the conductor width.

20. The inductor component according to claim 3, wherein
the inductor conductor includes a seed layer that is in contact with a surface of the interlayer insulation layer facing in the first positive direction and that extends parallel to the main surface,
in a specific cross section perpendicular to a center line of the inductor conductor, the inter-conductor insulation layer includes a plurality of portions that are discontinuous in a direction along the main surface, and
in the specific cross section, when a conductor width is defined as a shortest distance between the portions of the inter-conductor insulation layer and a seed layer width is defined as a largest dimension of the seed layer located between the portions of the inter-conductor insulation layer in a same direction as the conductor width,
the seed layer width is from 40% to 90% of the conductor width.
